(19) United States
(12) Patent Application Publication
(10) Pub. No.: US 2013/0057000 A1
(43) Pub. Date: Mar. 7, 2013

(54) MOTOR VEHICLE WITH CRASHBOX

(71) Applicants: Hans-Joachim PATSCHICKE, Otterberg (DE); Jens HARTMANN, Floersheim (DE)

(72) Inventors: Hans-Joachim PATSCHICKE, Otterberg (DE); Jens HARTMANN, Floersheim (DE)

(73) Assignee: GM GLOBAL TECHNOLOGY OPERATIONS LLC, Detroit, MI (US)

(21) Appl. No.: 13/600,583

(22) Filed: Aug. 31, 2012

(30) Foreign Application Priority Data
Sep. 2, 2011 (DE) 10 2011 112 256.0

(51) Int. Cl. B60R 19/34

(52) U.S. Cl. 293/133; 296/187.09

(57) ABSTRACT

A motor vehicle with a crashbox is provided. The motor vehicle includes a side member, a bumper, and a crashbox that connects the bumper to the side member. A wall of the crashbox in section along a section plane extending in longitudinal direction of the crashbox has waves. The amplitude of the waves in longitudinal direction of the crashbox is variable.

### CROSS-REFERENCE TO RELATED APPLICATION

This application claims priority to German Patent Application No. 10 2011 112 256.0, filed Sep. 2, 2011, which is incorporated herein by reference in its entirety.

### TECHNICAL FIELD

The technical field relates to a motor vehicle having a side member, a bumper and a crashbox, which connects the bumper to the side member and is provided in order to dissipate impact energy in the event of a collision through deformation and by doing so avoid a deformation of the side member that can only be rectified again subject to major difficulties.

### BACKGROUND

From DE 10 2007 035 483 A1, a crashbox is known, wherein an upper and a lower wall of the crashbox in section comprises waves along a section plane extending in longitudinal direction of the crashbox. The waves form weak points of the crashbox, on which the deformation of the crashbox commences during a collision. The waves do not differ from one another in cross section, so that eventualities such as for example a wall thickness varying within the scope of manufacturing tolerances and the microstructure of the metal at an influence on which of the plurality of waves yields first in the event of a collision. When on the upper and lower wall different waves yield first, this can lead to another deformation than when the deformation on both waves commences on the same wave, and the amount of energy which the crashbox can dissipate before the side member is affected, can vary from case to case.

It is at least one object herein to create a motor vehicle with a crashbox that is able to reliably dissipate a high amount of energy in a reproducible manner. In addition, other objects, desirable features and characteristics will become apparent from the subsequent summary and detailed description, and the appended claims, taken in conjunction with the accompanying drawings and this background.

In an exemplary embodiment, a vehicle having a side member, a bumper and a crashbox, which connects the bumper to the side member, wherein at least one wall of the crashbox in section comprises waves extending in longitudinal direction of the crashbox, is provided. The amplitude of the waves is variable in longitudinal direction of the crashbox. The amplitude influences the yield of the wave under a force acting in longitudinal direction of the crashbox during a collision, and by rendering the yields distinct from one another, the sequence in which the waves start to deform during a collision can be determined, i.e., a reproducible deformation behavior is achieved.

It is practical, in particular, when the amplitude of the waves increases from the side member to the bumper. The plastic deformation in each case then commences on the waves next adjacent to the bumper and, depending on the strength of the load, can expand over additional waves towards the side member. Thus, in the ideal case, an upsetting deformation starting out from the bumper can spread out beyond the crashbox to a greater or lesser degree depending on the strength of the collision.

The load capacity of the waves also depends on the extent to which the rotation of the waves deviates from the longitudinal direction of the crashbox or the direction of the force effect. The greater the deviation, the smaller the load capacity. For this reason, the maximum direction deviation from the vehicle longitudinal direction in the case of a wave adjacent to the bumper is preferentially greater than in the case of a wave adjacent to the side member.

Deferentially, the waves are locally congruent; this allows forming them with a same tool despite different amplitude, in that merely the deflection of the tool is varied from one wave to another.

In an exemplary embodiment, the waves in a wall of the crashbox comprise a region between two flat regions extending in a same plane that is deflected out of the plane transversely to the longitudinal direction of the crashbox. Such a wall can be formed with little effort by pressing a tool, as mentioned above, against an originally flat wall.

In order to be able to be anchored on the side member in a fixed manner, the crashbox in an embodiment comprises a main section extending between a tip of the side member and an anchorage section inserted in an open end of the side member.

The crashbox can be produced in a simple and economical manner in that elements, which form one or a plurality of walls of the crashbox, are interconnected by way of flanges marginally standing away. The individual elements can then be cost-effectively formed from flat material.

In an embodiment, the interconnected flanges of the elements are provided with notches each overlapping one another in order to facilitate a buckling also of the flanges under load.

To avoid that the flanges interfere with the yielding behavior of the waves, in particular with a start of the yielding at the height of the wave with the highest amplitude, in an embodiment, the distance between two of the notches correspond to the length of the waves or a whole-number fraction thereof.

In another embodiment, in order to avoid problems during the insertion in the side member, the flanges practically end at the transition from the main section to the anchorage section of the crashbox.

In a further embodiment, in the anchorage section, the elements of the crashbox are unconnected among one another; for example, they do not touch one another there. This facilitates their anchoring in the side member or the risk that the side member is deformed through the attachment of the crashbox is minimized.

In still another embodiment, front edges of the elements are welded to the bumper.

### BRIEF DESCRIPTION OF THE DRAWINGS

The various embodiments will hereinafter be described in conjunction with the following drawing figures, wherein like numerals denote like elements, and wherein:

FIG. 1 is a perspective view of a bumper having two crashboxes according to an embodiment;

FIG. 2 is a schematic longitudinal section of an insulated crashbox according to an embodiment;

FIG. 3 is a lateral view of the crashbox from FIG. 2;

FIG. 4 is a schematic longitudinal section of a channel-shaped element of a crashbox according to another embodiment; and

FIG. 5 is a cross section through an anchorage section of a crashbox fastened to a side member according to an embodiment.

### DETAILED DESCRIPTION

The following detailed description is merely exemplary in nature and is not intended to limit the embodiments or the application and uses thereof. Furthermore, there is no intention to be bound by any theory presented in the preceding background or the following detailed description.

In a perspective view from the outside, according to an exemplary embodiment, FIG. 1 shows a bumper 1 of a motor vehicle, in particular of a passenger car, with two crashboxes 2 fastened to its back. The bumper 1 in this case is a simple single-walled steel profile of substantially C-shaped cross section with a front plate 3 stiffened through two beads 4 stamped in in vehicle transverse direction between the crashboxes 2 and flanks 5 horizontally angled-off from the upper and lower edge of the front plate 3 to the vehicle interior. The crashboxes 2 engage in the hollow space at the back of the bumper 1 delimited by the front plate 3 and the flanks 5 from the vehicle inside, where they are welded together.

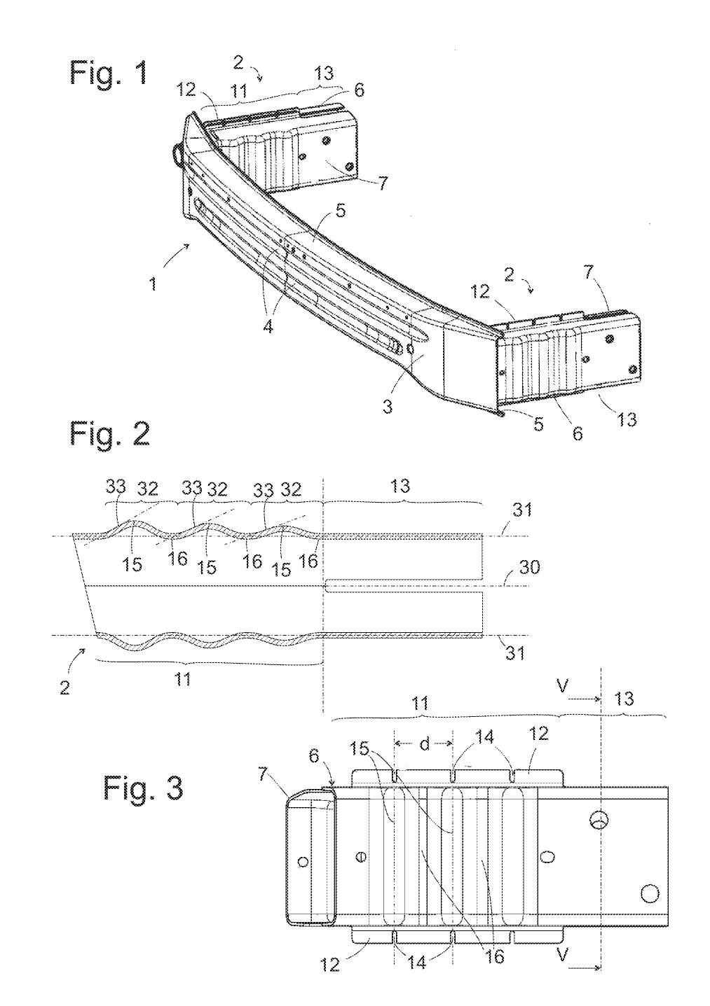

In one embodiment, the crashboxes 2 in turn each comprise two substantially channel-shaped elements, which like the bumper 1 are formed of steel plate and of which one each arranged towards the vehicle outside is designated 6 and one each arranged towards the vehicle center is designated 7. The channel-shaped elements 6, 7 each have a large-area vertical wall 8, as is evident in particular in FIG. 2, and angled-off horizontal flanks 9, 10 on its upper and lower edge. On a section 11 (see FIG. 1) facing the bumper 1, in the following also called main section, of the crashbox 2, strip-shaped flanges 12 welded together are angled off on the edges of the horizontal flanks 9, 10 of the elements 6, 7 facing each other. The surfaces of the flanges 12 of the elements 6, 7 contacting one another lie in a same vertical plane, which is designated 30 in FIG. 2. In a section facing away from the bumper 1, designated anchorage section 13, the flanges 12 are absent.

FIG. 2 shows a longitudinal section through one of the crashboxes 2 along a horizontal section plane running through the vertical walls of both elements 6, 7. In one embodiment, in the anchorage section 13, the vertical walls 8 run in a straight line and parallel to the plane 30 in two planes each designated 31. In the main section 11, the walls 8 are wave-shaped in longitudinal section. FIG. 2 shows three complete waves 32 on each wall 8; the number of the waves can also be greater or smaller, or element 7 located inside, since it is longer than the element 6 located outside, can have more waves than the latter.

In an embodiment, wave troughs 16 of the waves 32 in each case lie in the plane 31; wave crests 15 are deflected out of the plane 31 towards a side facing away from the plane 30, specifically the more, the further away they are from the anchorage section 13. Dash-dotted lines 33 are tangents on those locations of the wall 8, on which the directional deviation from the plane 31, i.e. the angle defined by the tangent 33 with the plane 31, reaches a local maximum. The angle, which is formed by the tangents 33 with the plane 31, visibly increases with the distance from the anchorage section 13. Both, the increasing amplitude of the waves 32 as well as the increasing directional deviation contributes to the fact that the deformation resistance of the waves 32 decreases from the anchorage section 13 towards the bumper. Under the loading of a collision the wave 32 next adjacent to the bumper therefore yields initially, than the one following this one, etc.

As is evident in particular in FIG. 3, the flanges 12 are subdivided by notches 14 at regular distances d, in accordance with another embodiment. The distance d of the notches 14 corresponds to the length of the waves 32 formed in the vertical walls 8; in the present case, the notches 14 are each located in planes, which also run through the wave crests 15 of the waves 32 formed in the walls 8. The notches 14 in each case arranged at the same distance d as the wave crests 15 also facilitate the yielding to the load of the flanges 12 which are welded together. During the upset-deformation of the crashbox 2, the notches 14 in each case alternately yield downwards and upwards as a rule, so that sections of the flanges 12, which are located on different sides of a same notch 14, each rotate in opposite direction.

According to further embodiment, further notches could be formed in the flanges 12 between each two notches 14 shown in FIG. 3, in particular halfway between each two of the notches 14, in a plane with the wave troughs 16. Since during an upset-deformation of the crashbox 2 the apexes 15 tend to move apart, the notches 14 then located on a same plane with these, can move together, while the notches in each case located in the plane of the wave troughs 16 moving together during upset-deformation, can move apart.

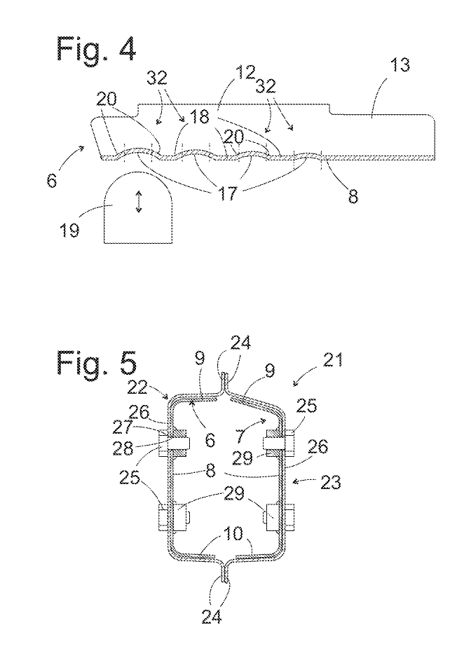

FIG. 4 shows a longitudinal section through a channel-shaped element 6 according to a further embodiment. The waves 32 in this case have the form of circular arc-shaped depressions 17 and flat sections 18 located in between in the otherwise flat vertical wall 8, wherein the depth of these depressions 17 increases from the anchorage section 13 to the left end of the element 6 acting on the bumper 1. The curvature radius is the same with all depressions 17, since these are obtained by pressing-in a same die 19 in each case with different depth in the wall 8. The contour of the rear-most, flattest depression 17 therefore congruently reappears in a central region of every other depression 17 as is indicated in the Figure through dash-line pairs. Edge sections 20, which adjoin this central congruent region, are always further deflected against the vehicle longitudinal direction from the back to the front, so that the force, at which a plastic deformation commences, becomes smaller in each case from a depression 17 to the next from the back to the front. In the case of a collision, the depressions 17 therefore collapse one after the other from the front to the back, so that a large amount of energy can be dissipated before a side member, to which the crashbox 2 is attached, is also affected.

FIG. 5 illustrates the type of attachment of the crashbox 2 in the side member by means of a cross section through the plane designated V-V in FIG. 3. Here, the flat vertical walls 8 and horizontal flanks 9, 10 of the two channel-shaped elements 6, 7 in the anchorage section 13 are evident. The side member 21, in which the anchorage section 13 is received, is formed, in a similar manner to the crashbox 2 in its main section 11, by two channel-shaped or hat-shaped profile elements 22, 23, whose edges angle-off towards the bottom and the top of each form flanges 24 which are welded together. The vertical walls 8 are held pressed against vertical walls 26 of the profile elements 22, 23 in a fixed manner by means of screws 25, wherein the screws 25 engage through bores 27, 28 of the walls 26, 8 into nuts 29 fixed, for example soldered, to the inside of the walls 8. Since the channel-shaped elements 6, 7 are unconnected among one another in the anchorage section 13, they can relatively easily yield to the force exerted on them during the tightening of the screws 25 without there being a risk of a deformation of the side member 20.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A motor vehicle comprising:
a side member;
a bumper; and
a crashbox that connects the bumper to the side member, wherein a wall of the crashbox in section along a section plane extending in a longitudinal direction of the crashbox comprises waves, wherein an amplitude of the waves in a longitudinal direction of the crashbox is variable.

2. The motor vehicle according to claim 1 wherein the motor vehicle is a passenger motor vehicle

3. The motor vehicle according to claim 1, wherein the amplitude of the waves increases from the side member towards the bumper.

4. The motor vehicle according to claim 1, wherein a maximum directional deviation from the motor vehicle's longitudinal direction in a case of a wave adjacent to the bumper is greater than in a case of a wave adjacent to the side member.

5. The motor vehicle according to claim 1, wherein the waves are locally congruent in section along the section plane.

6. The motor vehicle according to claim 1, wherein the waves in each case between two flat regions extending in a same plane comprise a region deflected out of the plane transversely to the longitudinal direction of the crashbox.

7. The motor vehicle according to claim 1, wherein the crashbox comprises a main section extending between a tip of the side member and the bumper and an anchorage section inserted into an open end of the side member.

8. The motor vehicle according to claim 7, wherein the crashbox is joined together from elements that are interconnected via flanges standing away at edges.

9. The motor vehicle according to claim 8, wherein the flanges are provided with overlapping notches.

10. The motor vehicle according to claim 9, wherein a distance between two of the overlapping notches corresponds to a length of the waves or a whole-number fraction thereof.

11. The motor vehicle according to claim 8, wherein the flanges end at a transition from the main section to the anchorage section.

12. The motor vehicle according to claim 8, wherein the elements of the crashbox do not touch one another in the anchorage section.

13. The motor vehicle according to claim 8, wherein front edges of the elements are welded to the bumper.
